(19) United States
(12) Patent Application Publication
(10) Pub. No.: US 2026/0300475 A1
(43) Pub. Date: Oct. 1, 2026

(54) Threat Intel Optimization and Operation

(71) Applicant: ITO DB Corporation, Westerville, OH (US)

(72) Inventor: Nate GUAGENTI, Westerville, OH (US)

(21) Appl. No.: 19/447,324

(22) Filed: Jan. 13, 2026

Related U.S. Application Data
(60) Provisional application No. 63/744,397, filed on Jan. 13, 2025.

(51) Int. Cl. G06F 21/55

(52) U.S. Cl. CPC G06F 21/552; G06F 2221/033

(57) ABSTRACT

Aspects of the present disclosure relate to standardizing and operationalizing threat intelligence data for cybersecurity applications. A threat intelligence optimization system can generate a portable, high-performance threat intelligence database by initially acquiring data, including digital identifiers and associated threat attributes, from multiple disparate data sources. The system can transform this data, packing numerous attributes into a single, structured data field. This consolidated data can be serialized into a file comprising a binary search tree for rapid lookups and a data section for storing the packed attributes. In some implementations, the file can be structured for compatibility with an existing database format, such as the MaxMind Database (MMDB) format. The system can enable existing security systems, such as firewalls and SIEMs, to natively consume and act upon this custom, enriched intelligence in real-time or near real-time, eliminating integration complexity and performance bottlenecks.

### CROSS-REFERENCE TO RELATED APPLICATIONS

This application claims priority to U.S. Patent Application No. 63/744,397, entitled “Threat Intel Optimization and Operation,” which is herein incorporated by reference in its entirety.

### TECHNICAL FIELD

The present disclosure is directed to systems and methods for standardizing and operationalizing data, such as threat intelligence data for cybersecurity applications, amongst other applications.

### BACKGROUND

In the field of network security, threat intelligence data is critical for identifying and mitigating malicious activities. Organizations often acquire this data (which can include digital identifiers such as IP addresses, domain names, and file hashes associated with known threats) from a multitude of providers and open-source feeds. This data can then be used by various security assets, such as firewalls, proxies, and Security Information and Event Management (SIEM) systems, to detect and block potential cyber intrusions.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for standardizing and operationalizing threat intelligence data for cybersecurity applications.

FIG. 5A is a flow diagram illustrating a process used in some implementations for acquiring and transforming threat intelligence data into a unified data model.

FIG. 5B is a flow diagram illustrating a process used in some implementations for serializing unified data models into a database file of threat intelligence data.

FIG. 5C is a flow diagram illustrating a process used in some implementations for querying a database file and operationalizing an action based on obtained threat intelligence data.

FIG. 6 is a conceptual diagram illustrating exemplary representations of disparate sets of threat intelligence data obtained from multiple data sources.

FIG. 7A is a conceptual diagram illustrating a representation of exemplary packed data retrieved from a database file for an Internet Protocol (IP) address.

FIG. 7B is a conceptual diagram illustrating a representation of data retrieved from a conventional geolocation database.

FIG. 7C is a conceptual diagram illustrating a representation of exemplary packed data retrieved from a database file for a Media Access Control (MAC) address.

FIG. 8A is a conceptual diagram illustrating a representation of an exemplary output from a security asset after querying a database file with a digital identifier.

FIG. 8B is a conceptual diagram illustrating a representation of an exemplary output from a security asset after querying a conventional geolocation database.

FIGS. 9A-C are conceptual diagrams illustrating representations of additional exemplary outputs from a security asset after querying a custom database file with various digital identifiers.

The techniques introduced here may be better understood by referring to the following Detailed Description in conjunction with the accompanying drawings, in which like reference numerals indicate identical or functionally similar elements.

### DETAILED DESCRIPTION

Existing methods for operationalizing threat intelligence suffer from significant drawbacks. The data acquired from different sources is often highly fragmented, arriving in a variety of disparate formats and schemas, such as JSON, CSV, or plain text. Consequently, organizations must invest substantial engineering resources to build and maintain complex data pipelines to normalize and consolidate this information before it can be used.

Furthermore, once a consolidated dataset is created, its use in real-time environments is often limited by performance bottlenecks. Storing the data in a traditional database and querying it for every network event introduces significant latency, which is often unacceptable for high-throughput security appliances. Alternatively, relying on external application programming interface (API) calls for real-time enrichment does not scale effectively and adds dependencies on external services. This lack of a standardized, high-performance method for integrating custom threat intelligence into a wide array of existing security and networking tools remains a persistent challenge.

Therefore, there is a need in the art for a more efficient system and method for aggregating threat intelligence from disparate sources and making it available for real-time consumption by a wide range of security and networking systems, without imposing significant performance overhead or requiring complex, custom integration efforts. Aspects of the present disclosure meet these needs and others by standardizing and operationalizing threat intelligence data for cybersecurity applications. A threat intelligence optimization system can generate a portable, high-performance threat intelligence database by acquiring data, including digital identifiers and associated threat attributes, from multiple disparate data sources. The system can transform this data, packing numerous attributes into a single, structured data field. This consolidated data can be serialized into a file comprising a binary search tree for rapid lookups and a data section for storing the packed attributes. In some implementations, the file can be structured for compatibility with an existing database format, such as the MaxMind Database (MMDB) format. In some implementations, the system can enable existing security systems, such as firewalls and SIEMs, to natively consume and act upon this custom, enriched intelligence in real-time or near real-time, eliminating integration complexity and performance bottlenecks.

The implementations described herein provide significant technological improvements in the fields of information processing, information storage, and cybersecurity, amongst other fields. Advantageously, the system described herein can integrate with existing database structures (e.g., via MMDB compatibility), directly addressing the problem of integration complexity. Conventional approaches would require creating a proprietary database, then forcing existing software (e.g., firewalls, SIEMs, proxies, etc.) to integrate with it. This would necessitate writing custom clients, plugins, or middleware for each of the hundreds of target applications, which is a prohibitively expensive and time-consuming task. Instead of creating a new, custom database structure, some implementations of the system described herein serialize its data into a pre-existing, widely adopted database format (MMDB in one example), which is a fundamental improvement in interoperability. With respect to the MMDB example, the system can generate a file that is structurally indistinguishable from a standard GeoIP database.

This approach can make the integration process trivial. A computing system running software like Elasticsearch, NGINX, or pfSense does not need to be re-architected or have its code modified. A system administrator can simply change a configuration setting to point to the custom database (e.g., MMDB file) instead of the default one. In some cases, the existing, highly optimized database file reader libraries already present in these applications can then natively read and query the custom threat intelligence data. This dramatically reduces implementation costs, eliminates the need for specialized engineering, and allows the computing system to leverage powerful new data with minimal overhead.

Further, some implementations described herein improve the computer's ability to process data by offloading the complex task of normalization to a pre-processing stage, standardizing disparate data into a unified, actionable format. Conventionally, a computing system trying to use raw data from multiple sources would need a complex array of parsers and conditional logic to handle different formats (e.g., JSON, CSV, unstructured text, etc.) and inconsistent field names (e.g., “reputation.0.category” vs. “category”). This can make the end-user application bloated, slow, and difficult to maintain.

Thus, some implementations described herein perform a data acquisition and transformation stage that can act as a powerful data refinery. For example, the system can “pack” or “nest” data, where numerous disparate attributes can be intelligently transformed and consolidated into a single, structured data field (e.g., a JSON object). This creates a single, predictable, standardized, and unified data model for every digital identifier. Accordingly, the consuming system can be freed from the burden of parsing and normalization. Instead of needing complex logic to interpret dozens of potential fields from multiple sources, it only needs to parse one single, well-structured field. This simplifies the logic required within the security asset, reduces its processing overhead, and makes it function more efficiently. The heavy lifting can be done once during file generation, as opposed to millions of times during real-time lookups at runtime.

Further, the system described herein fundamentally changes the data retrieval mechanism, leading to significant performance gains, such as a drastic reduction in latency and improved search efficiency. Traditional search methods are slow. For example, querying a remote API over a network introduces high latency (milliseconds or more). Querying a conventional disk-based database involves slow I/O operations. Neither is suitable for high-throughput systems that must process millions of events per second.

In some implementations, the system described herein combines two technologies for maximum speed: a binary search tree structure and in-memory operation. Digital identifiers are stored in the binary search tree, which allows for lookups with logarithmic time complexity (O(log n)). This is inherently faster for this type of data than the indexing methods used by general-purpose databases. Further, in some implementations, the MMDB file format is designed to be loaded entirely into the consuming computer's RAM. By performing lookups directly in memory, the system can avoid slow disk or network I/O. The computer's CPU can retrieve the required data in microseconds, not milliseconds, in some cases. This minimizes CPU wait cycles and allows the system to handle a vastly higher rate of transactions. For a firewall or proxy, this means it can inspect and make decisions on network traffic at line speed without becoming a bottleneck. The computer's core function (e.g., processing data) becomes orders of magnitude more efficient.

Thus, by integrating seamlessly, standardizing nonstandardized data in disparate formats upfront, and enabling near-instantaneous in-memory lookups, the implementations described herein provide a comprehensive technological solution that improves the efficiency, speed, and intelligence of the computing systems that use it.

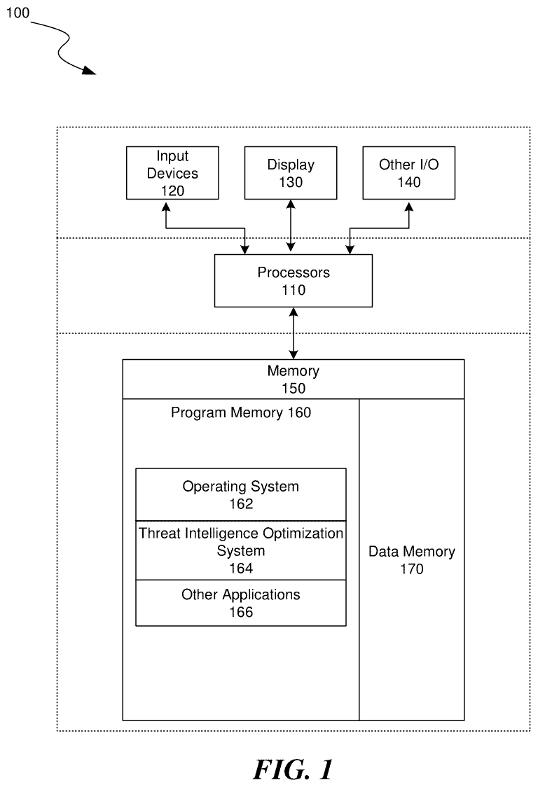

Several implementations are discussed below in more detail in reference to the figures. FIG. 1 is a block diagram illustrating an overview of devices on which some implementations of the disclosed technology can operate. The devices can comprise hardware components of a device 100 that can standardize and operationalize threat intelligence data for cybersecurity applications. Device 100 can include one or more input devices 120 that provide input to the Processor(s) 110 (e.g., CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera-or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, threat intelligence optimization system 164, and other application programs 166. Memory 150 can also include data memory 170, e.g., threat intelligence data, digital identifier data, attribute data, formatting data, pointer data, search tree data, query data, configuration data, settings, user options or preferences, etc., which can be provided to the program memory 160 or any element of the device 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to perform steps as shown and described herein.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

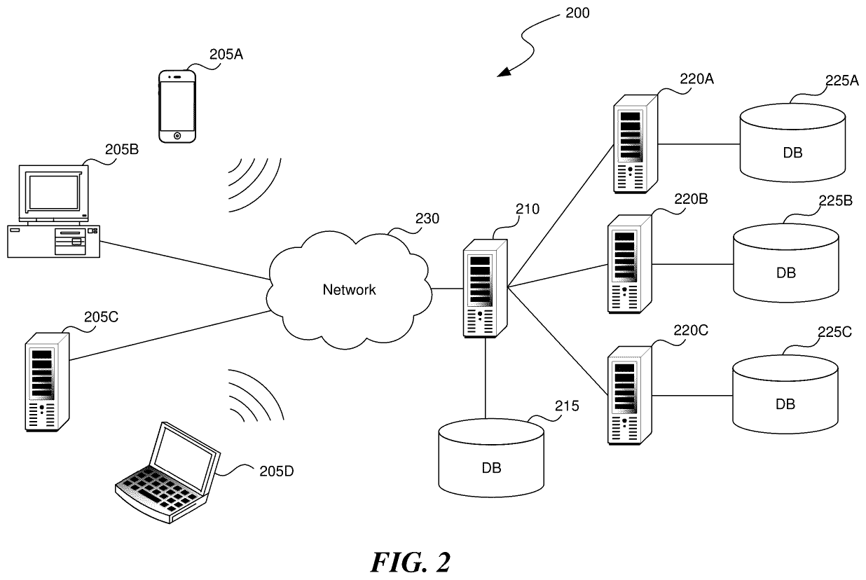

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as threat intelligence data, digital identifier data, attribute data, formatting data, pointer data, search tree data, query data, and/or the like. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

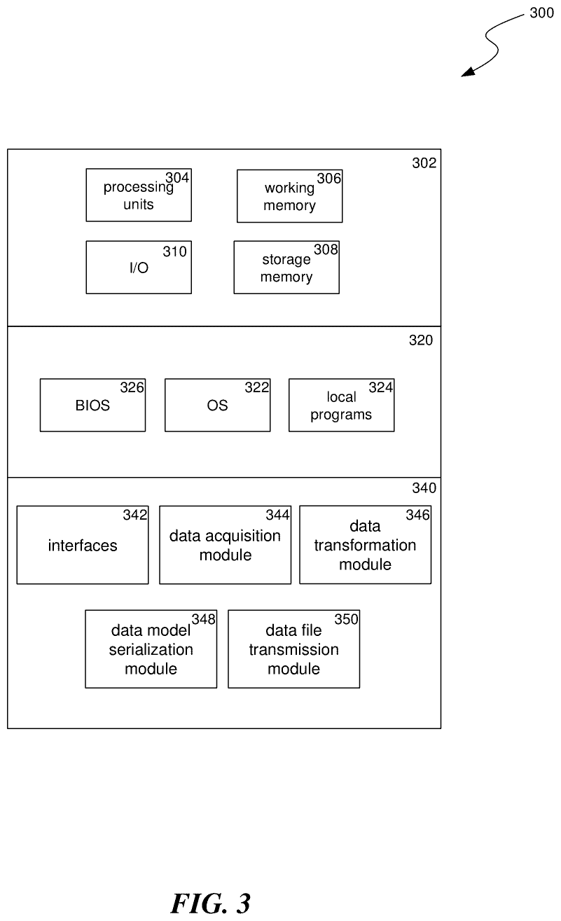

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include data acquisition module 344, data transformation module 346, data model serialization module 348, data file transmission module 350, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

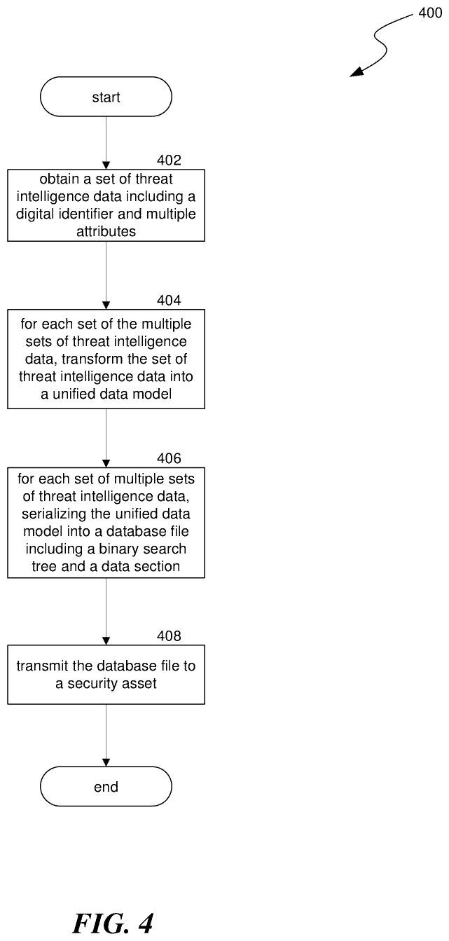

Data acquisition module 344 can obtain, from one or more data sources, multiple data sets. Each data set can include a digital identifier and multiple attributes associated with the digital identifier. In some implementations, the multiple data sets can include multiple sets of threat intelligence data, such as corresponding to detected cybersecurity threats. In some implementations, the one or more data sources can include multiple disparate computing systems, with each computing system storing respective data sets in a non-standardized format based on their individual hardware and/or software components, requirements, and/or capabilities. The digital identifier can function as a primary lookup key and can be any data sequence that can be represented in a binary format for high-speed searching. The attributes can provide the contextual payload for a given digital identifier and can be the basis for subsequent operational actions. For a threat intelligence application, these attributes can include, for example, a threat classification (e.g., ‘Command and Control’ or ‘phishing’), a confidence score, contextual data from security frameworks, etc. For non-cybersecurity applications, the attributes can include logistical data for a physical asset, such as a cargo manifest or destination, or a status description, such as ‘Stolen Vehicle’. Further details regarding obtaining, from one or more data sources, multiple data sets including a digital identifier and multiple attributes are described herein with respect to block 402 of FIG. 4.

Data transformation module 346 can, for each of one or more sets of the multiple data sets, transform the obtained data set into a unified data model, including packing the multiple attributes into a single packed data field, such as a serialized data object. For example, in a cybersecurity application, data transformation module 346 can consolidate threat intelligence data, associated with a single digital identifier and obtained from three different providers (one supplying a numerical score, another a textual category, and a third a list of associated malware families) into a single, structured, serialized object like a JSON string. Thus, in some implementations, data transformation module 346 can effectively create a standardized, predictable data structure for every digital identifier, abstracting away the complexity, inconsistency, and non-standardized formats of the raw source data before it is written to the final file. Further details regarding transforming an obtained data set into a unified data model are described herein with respect to block 404 of FIG. 4.

Data model serialization module 348 can, for each of one or more sets of the multiple data sets, serialize the unified data model into a database file. The database file can include a binary search tree and a data section. In some implementations, data model serialization module 348 can structure the file to be compatible with an existing database format including field(s) that, by default and in standard operation and/or by standard definition(s), do not correspond to the type of data serialized into such field(s) by data model serialization module 348. For example, multiple cybersecurity threat attributes (e.g., threat category, threat risk score, threat type, etc.) can be consolidated into a single packed data field by data transformation module 346, which data model serialization module 348 can place into a “country” field of a geolocation database format, such as a MaxMind Database (MMDB) format. The binary search tree can serve as a high-speed index for the digital identifiers, and the separate data section can store the attribute payloads. The nodes within the tree can be populated with pointers that function as direct memory addresses, creating a link that directs a lookup from a path in the tree to the precise location of the corresponding packed data field in the data section. Further details regarding serializing a unified data model into a database file including a binary search tree and a data section are described herein with respect to block 406 of FIG. 4.

Data file transmission module 350 can transmit the database file to a consuming computing system. The consuming computing system can include, for example, any one or more of, or any combination of, computing devices, components thereof, and/or applications configured to execute one or more actions based on data retrieved from the database file. In some implementations, the consuming computing system can include a security asset, as defined further herein. In some implementations, the consuming computing system can load the database file into memory for real-time access. Further details regarding transmitting a database file to a consuming computing system are described herein with respect to block 408 of FIG. 4.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for standardizing and operationalizing threat intelligence data for cybersecurity applications. In some implementations, process 400 can be performed as a response to obtaining a set of threat intelligence data corresponding to a detected cybersecurity threat. In some implementations, process 400 can be performed by a computing system, such as a backend data processing system including a server or cluster of servers. In some implementations, the computing system (or a portion thereof) can be on-premise. In some implementations, the computing system (or a portion thereof) can be in a cloud or edge environment.

In some implementations, the computing system can be operated and/or managed by an entity creating and/or providing a threat intelligence optimization system as described herein. For example, the entity can include any organization that operates a network to protect infrastructure, such as a company, a governmental entity, an educational entity, an individual, a group of individuals, etc. For example, the entity can be a cybersecurity or threat intelligence company, an enterprise with an advanced security team (e.g., a corporation), a managed security service provider (MSSP), and/or the like. In some implementations, process 400 can be performed by threat intelligence optimization system 164 of FIG. 1. In some implementations, process 400 can be performed by specialized components 340 of FIG. 3.

At block 402, process 400 can obtain, from one or more data sources, multiple sets of threat intelligence data corresponding to a detected cybersecurity threat. Each set of threat intelligence data can include a digital identifier and multiple attributes associated with the digital identifier. As used herein, a “digital identifier” can be a unique or semi-unique sequence of data that can serve to identify, address, or fingerprint a specific entity within a digital or physical system. It can be the primary “key” used to perform a lookup in a generated database file. The identifier can be represented as a string of characters or numbers which, in some implementations, can be converted into a binary format for processing by a binary search tree. Exemplary digital identifiers can include A) network and device identifiers (e.g., IP addresses, MAC addresses, etc.), B) software and data identifiers (e.g., file hashes, domain names, etc.), C) hardware and physical asset identifiers (e.g., mobile device identifiers, maritime identifiers, etc.), and/or the like.

As used herein, “attributes” can be a set of contextual data and metadata associated with a specific digital identifier. They can represent the payload of information that is retrieved upon a successful lookup and are the basis for subsequent decision-making and operational actions, as described further herein. In some implementations, the attributes, as obtained, can have heterogeneous formats and structures. In a cybersecurity application, the attributes can include threat intelligence attributes that can provide detailed context about a potential threat. For example, the attributes can include one or more of a threat description (e.g., a textual description of the threat), a threat category (e.g., a classification of the threat type, such as “malware” or “scanner”), a threat classification (e.g., sub-classifications or associated threat group names), a threat source (e.g., the provider or origin of the intelligence data), a threat score (e.g., a numerical value such as “97,” indicating the confidence level or severity of the threat), framework data (e.g., contextual information from established security frameworks), or any combination thereof.

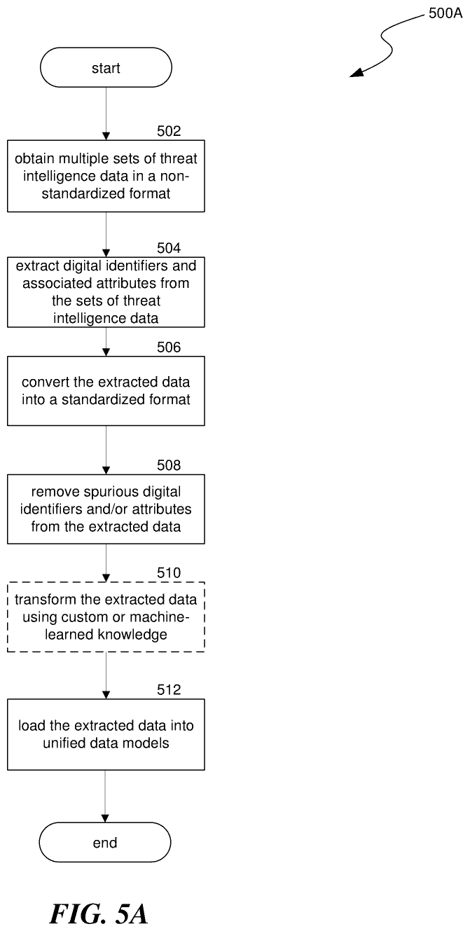

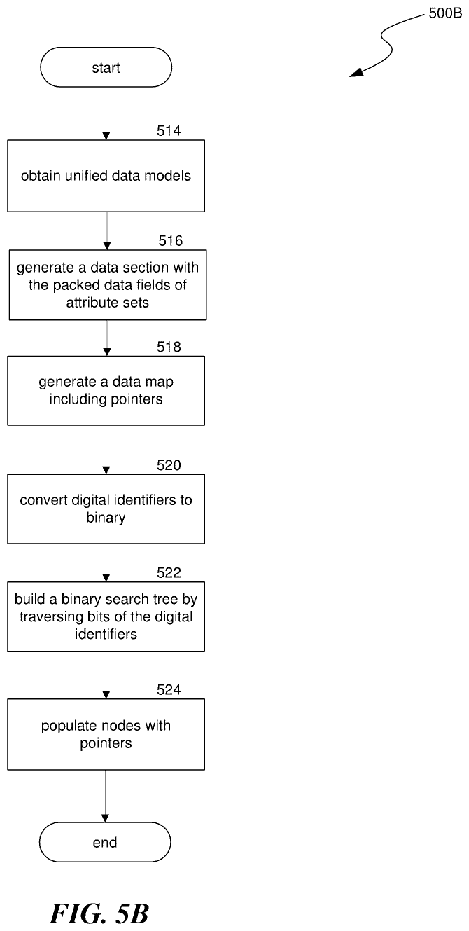

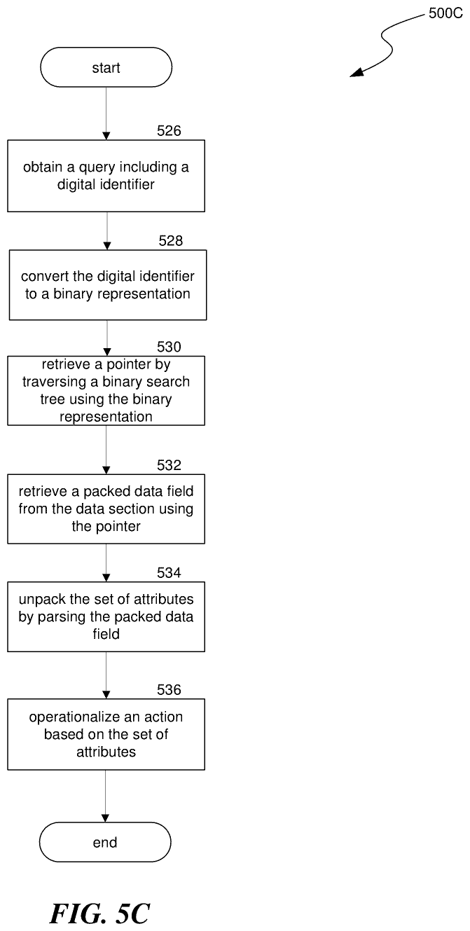

At block 404, for each set of the multiple sets of threat intelligence data, process 400 can transform the obtained set of threat intelligence data into a unified data model. Transforming the obtained set of threat intelligence data into the unified data model can include packing the multiple attributes into a single packed data field. In some implementations, the single packed data field can be a serialized, standardized structured data object (e.g., a JSON object). Further details regarding transforming obtained threat intelligence data into unified data models are described herein with respect to FIG. 5A.

At block 406, for each set of the multiple sets of threat intelligence data, process 400 can serialize the unified data model into a database file. In some implementations, the database file can be structured to be compatible with an existing (e.g., conventional) database format, such as a MaxMind Database (MMDB) format, without modification to the database format schema, allowing for seamless integration with existing software. The database file can include a binary search tree and a data section. The binary search tree can serve as a high-speed index and can be populated with multiple nodes. In some implementations, each node can represent a portion of a digital identifier. In some implementations, one or more nodes (e.g., “terminal nodes”) can include a pointer to a location in the data section, the latter of which can store the single packed data field representing the attribute information. Further details regarding serializing unified data models into a database file of threat intelligence data are described herein with respect to FIG. 5B.

At block 408, process 400 can provide the database file to a security asset, such as by transmitting the database file over a network. In some implementations, process 400 can provide the database file to the security asset based on a query and/or request for the database file. For example, process 400 can copy the database file to the security asset, which can then perform one or more further tasks relative to the database file. For example, the security asset can obtain a query including a newly detected digital identifier, which, in some cases, can correspond to an existing digital identifier represented in the binary search tree. In some implementations, the query can be triggered by a real-time event. For example, a firewall can make a query when it inspects an incoming network packet and extracts the source IP address. In another example, a log management platform can make a query when it ingests a log file containing a digital identifier, such as an IP address.

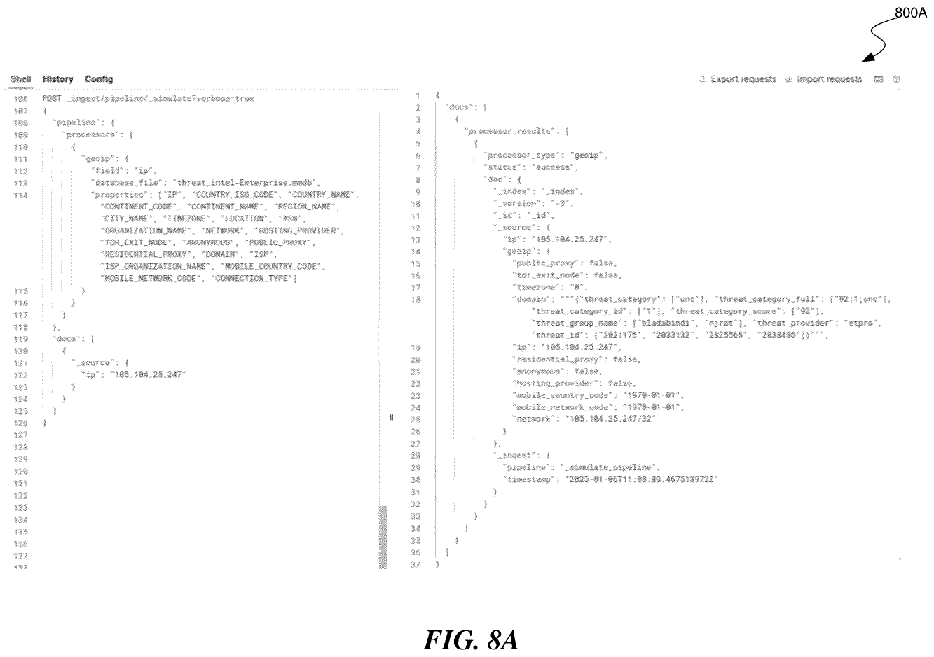

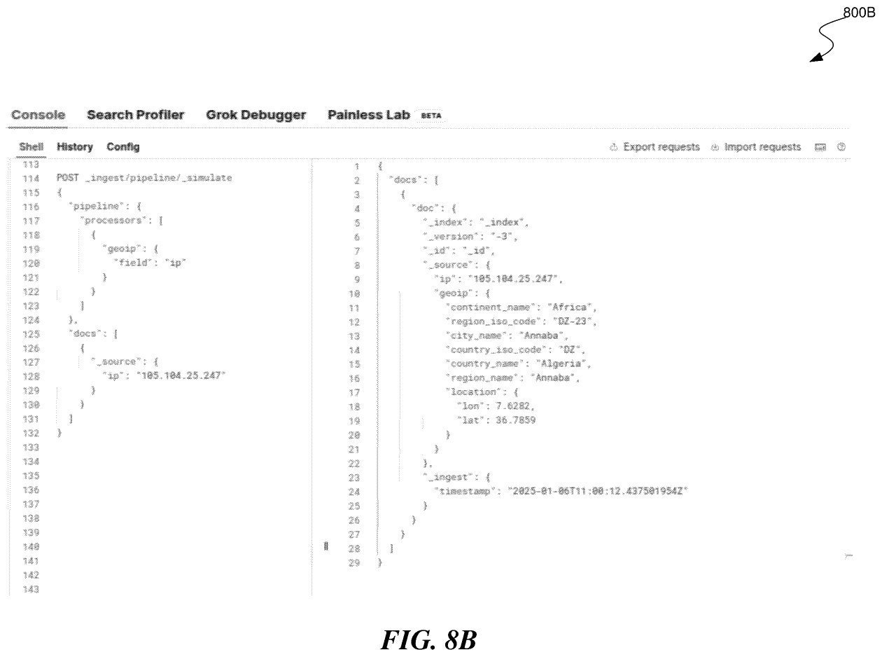

As used herein, a “security asset” can refer to a computing system, which may be a hardware appliance, a software application, or a virtual machine, that is configured to consume and/or utilize the portable threat intelligence database file generated by some implementations described herein. In some implementations, the security asset can query the intelligence stored within the database file, and convert the obtained threat intelligence data into a tangible, automated action. In some implementations, the security asset can have a native or pre-existing capability to read and process files in the database format used by process 400 (e.g., MMDB format). This can allow the security asset to seamlessly integrate the custom database file with minimal to no modification of its own source code, such as is illustrated by the example in FIG. 8A. Exemplary security assets can include a firewall, web server, proxy, data router, a SIEM tool, and/or the like.

The “existing digital identifier” included within the query can be the specific data element from the operational event for which the security asset seeks contextual information. This identifier can correspond to one of the types of digital identifiers for which data has been serialized into the database file, such as an IP address, a MAC address, or a file hash. The obtained query, containing this digital identifier, can serve as the direct input for the subsequent lookup process described relative to FIG. 5C, where process 500C can use the identifier to traverse the binary search tree and locate the corresponding data. In some implementations, the security asset can locate an existing pointer of a node of the binary search tree by traversing the binary search tree of the database file using the obtained digital identifier. In some implementations, before the traversal begins, the security asset can first convert the digital identifier obtained from the query into its corresponding binary representation, as the binary search tree can be structured to be navigated on a bit-by-bit basis. For example, an IPv4 address could be converted to a 32-bit string, while an IPv6 address or a MAC address might be converted to a 128-bit string to maintain a consistent structure.

In some implementations, the traversal process can begin at the root node of the binary search tree. The security asset can traverse the binary representation of the digital identifier one bit at a time, from most significant to least significant. For each bit, a decision can be made at the current node: if the bit is a “0”, process 400 can follow the pointer to the “left” child node; if the bit is a ‘1’, process 400 can follow the pointer to the “right” child node. This process can be repeated iteratively, moving from node to node deeper into the tree with each subsequent bit of the identifier's binary string. The traversal can continue until all bits of the binary representation have been processed. The final node reached at the end of this path can include the “existing pointer.” While intermediate pointers can be links to another node in the tree, the final pointer is not a link to another node in the tree, but rather a memory address or offset that can be used to retrieve the associated packed data field from the data section of the file.

In some implementations, the security asset can retrieve, using the located pointer, a packed data field from the data section of the database file. The “located pointer,” obtained from the traversal of the binary search tree, can be a direct memory address or offset. The security asset can use this address to jump directly to the specific location within the data section of the file where the corresponding data is stored. This mechanism provides a significant technological improvement by enabling a direct memory access operation, which is orders of magnitude faster than performing a full file scan or a disk-based query. In some cases, this high-speed retrieval can be critical for real-time applications, such as network firewalls or security analytics platforms, that must make decisions with minimal latency.

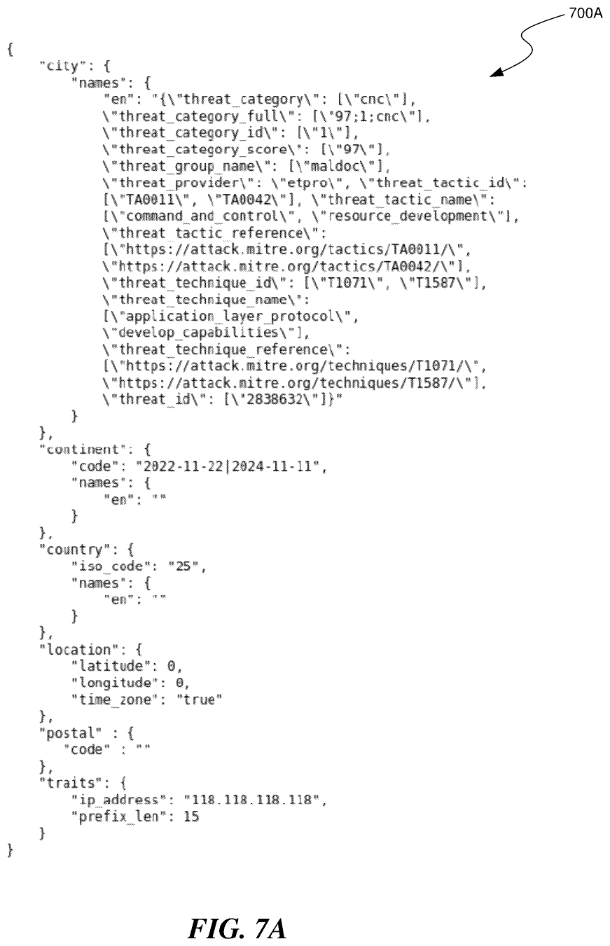

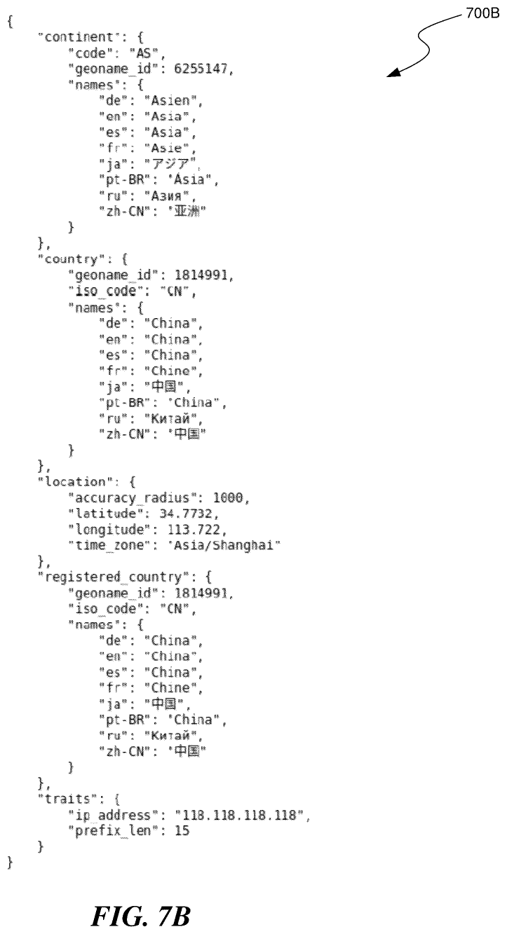

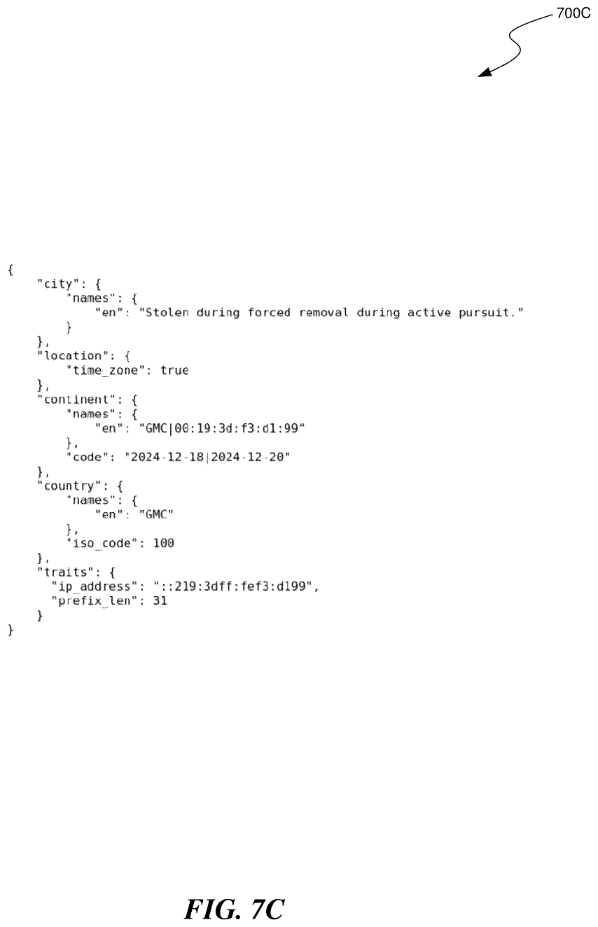

The data that is retrieved can be a packed data field (e.g., a serialized data object, such as a JSON string). In some implementations, the data field is not a single, simple value, but rather a consolidated container holding the multiple attributes that were processed and packed during a transformation stage (e.g., at block 404, if the existing data identifier corresponds to the digital identifier of the obtained threat intelligence data at block 402, although it is contemplated that the existing digital identifier can correspond to any digital identifier in the binary search tree having a pointer to attribute data in the data section). An exemplary representation of such a retrieved packed data field is shown in FIG. 7A. In this example, a single JSON string containing a plurality of threat attributes (including threat categories, scores, and framework data) is stored within a standard field of an MMDB-compatible structure. FIG. 7C further illustrates the flexibility of this approach, showing a packed data field including descriptive text about a physical asset, retrieved using a MAC address as the digital identifier.

The retrieved packed data field is the direct output of this step and can serve as the input for one or more subsequent processing steps. In some implementations, this field must be unpacked or parsed to extract the individual attributes before a security action can be operationalized. For example, in some implementations, the security asset can extract a plurality of threat attributes corresponding to the existing digital identifier by unpacking the retrieved existing packed data field. The packed data field, which in some cases is a serialized data object such as a JSON string, can be parsed to convert it from a single string into a structured object with accessible key-value pairs. This unpacking step can allow the security asset's internal logic to access and evaluate the specific attributes in order to make an informed decision.

In some implementations, the security asset can operationalize a security action based on one or more of the extracted plurality of threat attributes. After the individual threat attributes are extracted, the security asset can apply its own internal ruleset or logic to these attributes to determine an appropriate response. For example, an application's logic may be configured to check if the value of a “threat_score” attribute exceeds a predefined threshold or if a “threat_category” attribute matches a specific classification of interest. Based on the outcome of this logical evaluation, the application can then initiate a specific, pre-determined security action. Such security actions can include, but are not limited to, blocking a connection from the existing digital identifier, redirecting traffic associated with the digital identifier, or requiring additional authentication from a user or device associated with the digital identifier.

In some implementations, the security asset can perform the security action, putting the retrieved intelligence into practical use. This highlights the self-contained and efficient nature of the process, where the same entity that detects an event and initiates a query is also the entity that executes the resulting action. For example, a firewall that obtains a query for an incoming IP address can, upon receiving and unpacking the threat attributes, automatically perform the action of blocking that connection. Similarly, a SIEM tool like the Elasticsearch instance shown in FIG. 8A, which obtains the query during log ingestion, can automatically perform the action of enriching the log data with the retrieved attributes. This tight loop of query, retrieval, and automated action within a single security asset enables immediate, real-time responses to detected threats.

FIG. 5A is a flow diagram illustrating a process 500A used in some implementations for acquiring and transforming threat intelligence data into a unified data model. In some implementations, process 500A can represent a detailed flow corresponding to blocks 402 and 404 of FIG. 4. Specifically, process 500A can be performed to ingest raw, inconsistent, non-standardized data from a multitude of sources and transform it into a clean, standardized, and enriched data model that is ready for serialization.

As with process 400 of FIG. 4, process 500A can be performed as a response to obtaining a set of threat intelligence data corresponding to a detected cybersecurity threat. In some implementations, process 500A can be performed by a computing system, such as a backend data processing system including a server or cluster of servers. In some implementations, the computing system (or a portion thereof) can be on-premise. In some implementations, the computing system (or a portion thereof) can be in a cloud or edge environment. In some implementations, the computing system can be operated and/or managed by an entity creating and/or providing a threat intelligence optimization system as described herein, as with process 400 of FIG. 4. In some implementations, process 500A can be performed by threat intelligence optimization system 164 of FIG. 1. In some implementations, process 500A can be performed by specialized components 340 of FIG. 3.

At block 502, process 500A can obtain multiple sets of threat intelligence data in a non-standardized format. In some implementations, process 500A can acquire this data from one or more data sources, including external threat intelligence providers and/or internal data sources. For example, the sources can include commercial threat intelligence feeds, open-source intelligence (OSINT) repositories, internal logs, or any other provider of information related to threat intelligence. In some implementations, process 500A can obtain the sets of threat intelligence data from multiple disparate data sources.

In some implementations, the data sets can be highly disparate in their structure and content, and thus can be non-standardized in format. In some implementations, the data sets can include structured and/or unstructured data sets. For example, one data set may be in a structured JSON format with numerous nested attributes, while another data set may be in a simple, unstructured text or CSV-like format with minimal attributes. Process 500A can ingest these heterogeneous data sets, in all their different formats, as the raw input for processing in subsequent steps.

At block 504, process 500A can extract digital identifiers and associated attributes from the obtained sets of threat intelligence data. For a given set of threat intelligence data, the goal can be to identify and separate the digital identifier (e.g., the specific entity that the data pertains to, such as the IP address 118.118.118.118) and the associated attribute(s) (e.g., all other contextual information related to that digital identifier). For example, process 500A can parse the raw data, regardless of its original non-standardized format, to identify and isolate the core components in a set: the digital identifier that is the subject of the threat intelligence data (e.g., an IP address, domain name, or file hash) and all contextual attributes associated with it. In some implementations, for structured data, process 500A can read the key (the identifier) and the corresponding value (the attributes object). For unstructured data, process 500A can perform more complex parsing techniques, such as using regular expressions to find and extract IP addresses, domains, or other patterns from the text.

At block 506, process 500A can convert the extracted data into a standardized format. In some implementations, process 500A can load the extracted digital identifiers and attribute sets into a common, machine-readable serialized format, such as JSON, which allows for consistent programmatic access regardless of the original source format. This standardization can ensure that the subsequent processing steps can operate on the data in a consistent and predictable manner, abstracting away the complexities of the original source formats.

In some implementations, at block 508, process 500A can remove spurious digital identifiers and/or attributes from the extracted data. This step can focus on data cleaning and noise reduction. In some cases, raw intelligence feeds often contain redundant, irrelevant, or low-value information. In some implementations, process 500A can apply rules to remove these attributes to make the final data model more efficient and focused. For example, certain fields from original source data, such as asn.authorizer, asn.cidr, and location.0.ip, can be explicitly marked as “removed” during this step because they are deemed unnecessary for the final threat intelligence product.

In some implementations, at block 510, process 500A can transform the extracted data using custom or machine-learned knowledge. This is an enrichment step where the value of the data can be actively enhanced. In some implementations, process 500A can generate new, valuable data points that were not in the original source. In some implementations, process 500A can alter existing data for clarity (e.g., renaming source-specific field names to a common naming convention or restructuring data for clarity or consistency). For example, the source field reputation.0.category can be renamed to the more intuitive threat_category. In some implementations, process 500A can apply logic or machine learning models to derive new insights, scores, or classifications based on the combination of attributes from various sources.

At block 512, process 500A can load the extracted data into unified data models, with each unified data model corresponding to a set of threat intelligence data obtained at block 502. In this step, multiple attributes associated with a single digital identifier can be consolidated and “packed” into a single packed data field, such as a single JSON object. Instead of creating a flat structure with hundreds of columns, this can create a clean, final data structure where each unique digital identifier is mapped to a single, comprehensive attribute field. For example, instead of having separate fields for each MITRE tactic, process 500A can join them into a single array under the threat_tactic_id key: [“TA0011”, “TA0042”]. The output of this step is a clean key-value structure, for each set of threat intelligence data, where each unique digital identifier is mapped to a single packed data field (e.g., a JSON object) containing all of its consolidated, enriched, and relevant attributes. These unified data models can be the final output of process 500A. In some implementations, these unified data models can serve as the direct input for process 500B of FIG. 5B.

FIG. 5B is a flow diagram illustrating a process 500B used in some implementations for serializing unified data models into a database file of threat intelligence data. In some implementations, process 500B can represent a detailed flow of block 406 of FIG. 4. Specifically, in some implementations, process 500B can be performed to take the structured data produced by process 500A of FIG. 5A and create a single, portable, and highly efficient binary file optimized for rapid lookups.

In some implementations, process 500B can be performed as a response to obtaining unified data models corresponding to sets of threat intelligence data, such as are output from process 500A of FIG. 5A. In some implementations, process 500B can be performed by a computing system, such as a backend data processing system including a server or cluster of servers. In some implementations, the computing system (or a portion thereof) can be on-premise. In some implementations, the computing system (or a portion thereof) can be in a cloud or edge environment. In some implementations, the computing system can be operated and/or managed by an entity creating and/or providing a threat intelligence optimization system as described herein, as with process 400 of FIG. 4. In some implementations, process 500B can be performed by threat intelligence optimization system 164 of FIG. 1. In some implementations, process 500B can be performed by specialized components 340 of FIG. 3.

At block 514, process 500B can obtain one or more unified data models. These data model(s) can be the output of the transformation process described in FIG. 5A and can include a collection of key-value pairs. In the pairs, each key can be a unique digital identifier and each value can be the corresponding single packed data field containing all associated attributes.

At block 516, process 500B can generate a data section with the packed data fields of the unified data models. In some implementations, to optimize file size, process 500B can identify all unique sets of packed data fields and store each unique set only once within the data section. In some cases, this deduplication process can significantly reduce the overall file size. As each unique attribute set is written to the data section, its memory address or offset within the file is recorded.

At block 518, process 500B can generate a data map including pointers. This map can be a structure created in memory that links each digital identifier from the unified data model to the specific memory address or offset where its corresponding packed data field was stored within the data section at block 516. This data map can be used to populate the binary search tree with the correct pointers, as described further herein.

At block 520, process 500B can convert the digital identifiers to binary representations. The binary search tree can operate on a bit-by-bit basis, so each digital identifier (e.g., an IPv4 address, an IPv6 address, a MAC address, etc.) can be converted into its raw binary string representation (e.g., a 32-bit string for an IPv4 address). In some implementations, by converting each digital identifier into a binary representation, process 500B can use the same efficient binary search tree mechanism to store and retrieve intelligence about a vast range of entities, greatly expanding the applicability of the high-performance database beyond IP-based lookups.

At block 522, process 500B can build a binary search tree by traversing bits of the binary digital identifiers. Process 500B can construct the tree by traversing this binary string one bit at a time, starting from a single root node. For each bit, a decision is made to follow a “left” path for a ‘0’ bit or a “right” path for a ‘1’ bit. If a required path does not yet exist, a new node can be created. This bitwise construction allows the tree to store identifiers with shared prefixes in a highly compact manner, as they will share the same initial path of nodes. Although described primarily herein as a binary search tree, however, it is contemplated that similar techniques can be used to generate a numeric and/or alphanumeric search tree.

At block 524, process 500B can populate nodes of the binary search tree with the pointers. In some implementations, each node can represent a portion of a digital identifier, specifically a decision point corresponding to a single bit in the identifier's binary sequence. The collection of nodes, linked together by pointers, can form the complete tree structure that enables the rapid lookup of any stored digital identifier. In some implementations, these pointers can be of three types. First, internal pointers can be the links that form the structure of the tree itself, defining the “left” and “right” paths that guide the traversal from one node to the next based on the bit values of the identifier being searched. Second, an external pointer can be stored at the terminal node of the path for each unique digital identifier. This external pointer does not point to another node; instead, its value is the memory address, retrieved from the data map, that points directly to the location of the corresponding packed data field within the data section of the file. This pointer thus links the identifier's path in the tree to its associated attribute data, completing the structure of the database file. In some cases, however, the pointer can be “null,” such as when a terminal node corresponding to a last bit of the digital identifier has no associated data stored in the data section.

FIG. 5C is a flow diagram illustrating a process 500C used in some implementations for querying a database file and operationalizing an action based on obtained threat intelligence data. In some implementations, process 500C can be performed to run a query against the generated database file produced by process 500B of FIG. 5B and operationalize an appropriate action based on the obtained threat intelligence data. In other words, in some implementations, process 500C can describe the runtime consumption of the database file created in FIG. 5B. In some implementations, process 500C can be performed as a response to obtaining a query for threat intelligence data (e.g., detection of an event related to a digital identifier), such as is represented in a database file. In some implementations, process 500C can be performed by a security asset, as defined further herein.

In some implementations, however, process 500C can be performed by a computing system, such as a backend data processing system including a server or cluster of servers. For example, in some cases, the database file can be stored on a central computing system receiving queries from security assets including digital identifiers, and providing responses to queries to the security assets. In some implementations, the computing system (or a portion thereof) can be on-premise. In some implementations, the computing system (or a portion thereof) can be in a cloud or edge environment. In some implementations, the computing system can be operated and/or managed by an entity creating and/or providing a threat intelligence optimization system as described herein, as with process 400 of FIG. 4.

At block 526, process 500C can obtain a query including a digital identifier. In some implementations, this query can be initiated by a consuming application (an example of a security asset), such as a firewall, web server, or SIEM tool, in response to an event. For example, an event can include the detection of an incoming network packet containing an IP address, the ingestion of a log file containing a file hash, or the processing of a user transaction involving a device identifier. In some implementations, the event can be detected in real-time or near real-time, “on the fly,” at runtime, etc. In some implementations, however, the security asset need not detect an event to generate a query of the database file. In one example, the security asset can, on a predetermined schedule, generate queries for all connection and/or resource requests (or a random or determined subset thereof) historically made over the course of a predetermined amount of time, such as the past month, to take corrective actions preventing future access.

At block 528, process 500C can convert the digital identifier to a binary representation. In some cases, this conversion is necessary because the binary search tree within the database file is structured to be traversed on a bit-by-bit basis. In some implementations, the specific length of the binary representation can depend on the type of identifier (e.g., 32 bits for an IPv 4 address, 128 bits for an IPv6 address).

At block 530, process 500C can retrieve a pointer by traversing a binary search tree using the binary representation. In some implementations, process 500C can start at the root of the tree and follows a path of nodes (a “left” path for a ‘0’ bit and a “right” path for a ‘1’ bit) corresponding to the sequence of bits in the identifier's binary string. The terminal node of this path can include the pointer, which can be a memory address or offset that indicates where the associated data is stored.

At block 532, process 500C can retrieve a packed data field from the data section using the pointer obtained at block 530. Process 500C can use the pointer as a direct address to locate and read the corresponding serialized data from the data section. In some implementations, this direct lookup can avoid the need for a slow disk scan or traditional database query, enabling near-instantaneous data retrieval.

At block 534, process 500C can unpack the set of attributes by parsing the retrieved packed data field. In some implementations where the packed data field is a serialized object like a JSON string, block 534 can involve parsing the string to convert it back into a structured object that is programmatically accessible to a consuming application making the query, thereby exposing the individual threat attributes.

At block 536, process 500C can operationalize an action based on the set of attributes. In some implementations, the consuming application can apply its own internal logic to the individual attributes to make an intelligent, automated decision, such as by applying its own internal ruleset or logic, selecting a default action, determining an action from a lookup table of attributes mapped to actions selected based on those attributes, etc. For example, the security asset's logic may be configured to check if the value of a “threat_score” attribute exceeds a predefined threshold or if a “threat_category” attribute matches a specific classification of interest. Based on the outcome of this logical evaluation, process 500C can then initiate a specific, pre-determined security action. For example, a firewall can block a connection if an attribute indicates a high threat score, a SIEM tool can enrich a log file with the full set of unpacked attributes to provide context for an analyst, or a SOAR platform can use the attributes to trigger an automated incident response playbook.

In some implementations, process 500C can automatically perform the operationalized action. This highlights the self-contained and efficient nature of the process, where the same entity that detects an event and initiates a query can also be the entity that executes the resulting action. In some implementations, this tight loop of query, retrieval, and automated action within a single security asset enables immediate, in memory, real-time responses to detected threats.

The security action can encompass a wide range of automated responses, depending on the function of the security asset and the nature of the retrieved attributes. For example, a security asset functioning as a network control point, such as a firewall or proxy, can perform immediate preventative actions. This can include blocking a connection from the existing digital identifier if it is deemed malicious, redirecting the existing digital identifier to a honeypot for further analysis, and/or requiring additional authentication from a user or device (such as if the identifier is associated with suspicious, but not definitively malicious, activity). In another example, a security asset functioning as a data processor or analytics platform, such as a SIEM tool, can perform one or more enrichment actions. This can include, for example, storing the one or more of the extracted plurality of threat attributes in a database, often by appending them to the original log or event data that triggered the query. This action, such as is exemplified in FIG. 8A, can provide crucial context for subsequent analysis.

In still another example, the extracted attributes can be used to inform one or more further analytical processes. For example, this can include transmitting the one or more of the extracted plurality of attributes, such as to an analyst computing system. In some implementations, the analyst computing system can display the enriched data on a user interface dashboard to allow a human analyst to make a more informed decision and/or cause execution of one or more actions.

In some implementations, the extracted attributes, as a rich set of features, can be fed into a machine learning model or other artificial intelligence (AI)-driven analytics engine to perform one or more further actions, such as identify trends, score anomalies, update risk models, and/or the like. In some implementations, the machine learning model can be customized to calculate a dynamic, nuanced risk score for a digital identifier that, in some cases, can be more accurate than any risk score identified in an attribute of the data field. In some implementations, the machine learning model can be trained on historical data, learning the complex correlations between different attributes that lead to a malicious outcome. In some implementations, it can take multiple of or the entire set of extracted attributes as input (e.g., threat_score from Source A, threat_category from Source B, malware_family, MITRE tactics, the number of sources reporting the identifier, and the “days since last seen,” and/or the like), and weigh them together, which can include assigning different weights to different attributes.

For example, an IP address with a low threat_score of 40 might normally be ignored. However, the machine learning model can also see the attributes mitre_tactic_id: “TA0011” (Command and Control) and threat_group_name: “njrat”. The model has learned that whenever these three attributes appear together, there is a 95% probability of a real threat. It can therefore override the low threat score and assign a much higher, calculated risk score (e.g., 95/100) to the event. This moves from a simple “is it on the list?” check to a predictive assessment of “how likely is this to be malicious given everything we know about it?”.

In some implementations, a machine learning model can be customized to identify patterns that deviate from a learned baseline of normal behavior (i.e., detect “behavioral anomalies”). In some implementations, the machine learning model can be trained on the attribute profiles of “normal” traffic within an organization. When a new event occurs, the extracted attributes can be fed to the model, which can check if they fit the normal pattern.

For example, a user's device can normally generate traffic with attributes like country: “US”, asn_owner: “Provider123”. Suddenly, a digital identifier associated with that user can be detected, and the extracted attributes can be country: “RU”, asn_owner: “Obscure-Hosting-Provider”, and threat_category: “anonymous_proxy”. Even if this specific identifier is not on any threat list (e.g., a “zero-day” indicator), the combination of attributes can be a massive deviation from the user's normal behavior. The machine learning model can flag this as a high-risk anomaly worthy of investigation. In some implementations, this can enable the detection of novel and emerging threats that have no pre-existing signature, a critical weakness of purely rule-based systems.

In some implementations, a machine learning model can use a rich set of attributes to automatically classify the type and severity of a threat, which, in some cases, can dramatically speed up incident response. In some implementations, a classification model can be trained to map specific combinations of attributes to incident types. For example, an event's extracted attributes can include malware_family: “Ryuk” and mitre_technique_id: “T1486” (Data Encrypted for Impact). The machine learning model can classify this event as a “Critical Ransomware Incident.” This classification can then be used to trigger a specific, high-priority automated response (e.g., immediately isolating the host from the network) and route the alert directly to a senior incident response analyst, bypassing Tier 1 support. This can reduce “alert fatigue” and automate the initial triage process, allowing analysts to focus their efforts on the most critical threats.

Further, in some implementations, the extracted attributes can be used for adaptive learning and model improvement by creating a feedback loop that allows the entire optimization system to improve over time. For example, after an event is processed and an analyst provides a final disposition (e.g., “True Positive-Phishing Attack”), that outcome can be fed back into the machine learning model. The original set of extracted attributes that led to the event can now be paired with a confirmed, ground-truth label.

For example, a machine learning model can initially score an event as 60. An analyst can investigate and confirm that it was a real threat. The system can retrain the model with this new information and learn that this particular combination of attributes is more dangerous than it originally thought. The next time it sees a similar set of attributes, it can assign a higher score (e.g., 85). Thus, in some implementations, the security posture is advantageously no longer static. It can continuously and dynamically adapt and improve its detection capabilities as new threats are identified and new intelligence is gathered.

Although described primarily herein relative to detecting and/or querying the database file with a “known” or “existing” digital identifier (e.g., a digital identifier having an associated packed data field of attribute data stored in the database file), in some implementations, it is contemplated that a security asset can query the database file with a digital identifier that does not exist in the database file and/or is not associated with attributes previously stored in the database file. In such examples, the search can fail because the identifier's path does not exist in the binary tree and/or the last node does not include a pointer to a packed data field. In these cases, the database file reader library can inform the security asset that no data was found. In some implementations, the security asset can then execute its default “no threat detected” behavior, which can be, for example, to permit, ignore, or de-prioritize the event associated with the unknown identifier. In some implementations, this “default-allow” posture can be highly efficient, as it allows the security asset to focus its resources exclusively on the identifiers that are positively identified as threats by the custom database.

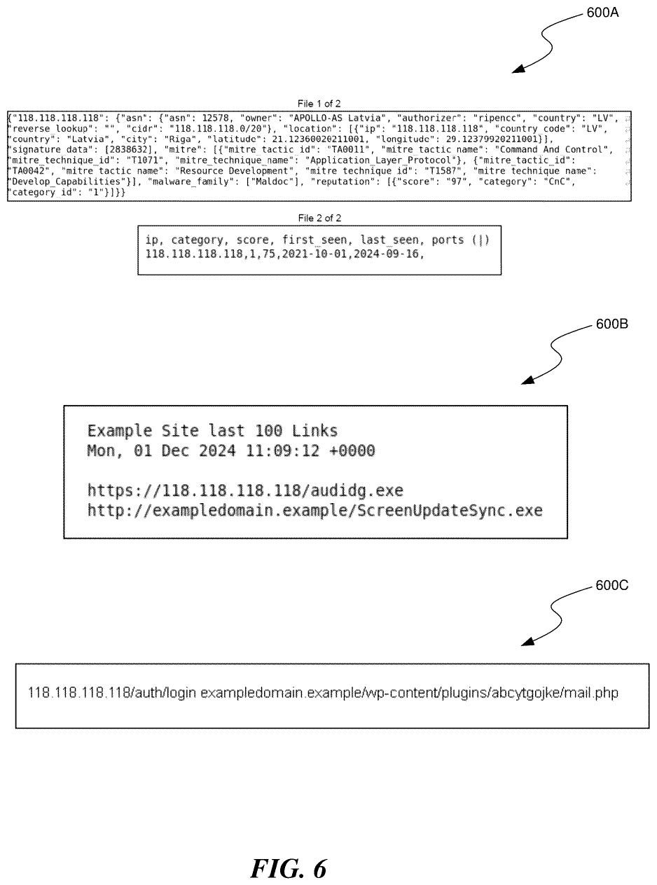

FIG. 6 is a conceptual diagram illustrating exemplary representations 600A-C of disparate sets of threat intelligence data obtained from multiple data sources. FIG. 6 illustrates the heterogeneous nature of the input data that the system is configured to acquire and process, such as described at block 502 of process 500A of FIG. 5A.

First representation 600A shows an example of data obtained from a single threat intelligence source for a single digital identifier; in this case, the IP address “118.118.118.118”. This representation demonstrates that even a single source may provide data in multiple, inconsistent formats. “File 1 of 2” of first representation 600A is a rich, structured JSON object containing numerous nested attributes, such as Autonomous System Number (ASN) information under the “asn” key, location data under the “location” key, and detailed threat context under the “mitre”, “malware_family”, and “reputation” keys. In contrast, “File 2 of 2” of first representation 600A provides data for the same IP address in a different, simpler, comma-separated format, containing only a few attributes such as a category, a score, and first and last seen dates.

Second representation 600B illustrates an example of a semi-structured or unstructured data source. In this example, digital identifiers, such as the IP address “118.118.118.118” and the domain “exampledomain.example”, are embedded within raw text and URLs. Unlike the structured data in first representation 600A, this data lacks explicit, machine-readable key-value pairs for its attributes, requiring more complex parsing to extract the relevant information. Third representation 600C provides another example of an unstructured data source, showing a single URL string that contains both an IP address (“118.118.118.118”) and a domain name (“exampledomain.example”).

Collectively, representations 600A-C highlight the significant technical challenge of data heterogeneity that some implementations described herein are designed to overcome. The data varies in format (JSON, CSV, unstructured text), structure (nested objects vs. flat files), and attribute richness. The transformation process described herein (such as detailed in FIG. 5A) is configured to ingest all of these disparate data sets, extract the relevant digital identifiers and attributes, and normalize them into the unified data model that is subsequently used to generate the portable threat intelligence database file.

FIG. 7A is a conceptual diagram illustrating a representation 700A of exemplary packed data retrieved from a database file for a digital identifier; in this case, an Internet Protocol (IP) address. Representation 700A illustrates the structure and content of the data that is returned to a security asset after a successful lookup, such as described in block 532 of process 500C of FIG. 5C. In this example, representation 700A is designed to be compatible with a standard MaxMind Database (MMDB) format, utilizing familiar top-level keys such as “city”, “continent”, “country”, “location”, “postal”, and “traits”. However, the threat intelligence optimization system described herein can repurpose these standard fields to store custom, consolidated threat intelligence.

The concept of data packing is exemplified by the value associated with the “city”->“names”->“en” key. Instead of a simple string representing a city name, this field contains a single packed data field, which in this example is a serialized JSON object. This packed field encapsulates a rich set of threat attributes that have been acquired, transformed, and consolidated from one or more threat intelligence sources. As shown, this packed data includes a plurality of threat attributes such as “threat_category” (e.g., “cnc”), “threat_group_name” (e.g., “maldoc”), “threat_score” (e.g., “97”), and detailed framework data, including tactic and technique identifiers, names, and reference URLs.

Furthermore, representation 700A demonstrates how other standard MMDB fields can be repurposed to convey custom information. For instance, the “continent”-> “code” field can be used to store a date range (e.g., “2022 Nov. 22|2024 Nov. 11”), which may represent the first and last times the digital identifier was observed. Similarly, the “country”->“iso_code” field can include a custom numerical value (e.g., “25”), which may represent a calculated metric such as the number of days since the identifier was last seen. The “traits” object can confirm the identity of the digital identifier that was queried, showing the “ip_address” as “118.118.118.118”. By packing a large volume of diverse threat intelligence data into a single field within a standard, compatible structure, representation 700A illustrates how the threat intelligence optimization system described herein can enable a security asset to retrieve a comprehensive threat profile in a single, efficient lookup. The security asset can then parse this packed data field to unpack the individual attributes and operationalize a security action, such as described in blocks 534 and 536 of process 500C of FIG. 5C.

FIG. 7B is a conceptual diagram illustrating a representation 700B of data retrieved from a conventional, off-the-shelf geolocation database, such as a standard MaxMind GeoIP2-City database. FIG. 7B is provided for the purpose of comparison to illustrate the novel and nonobvious manner in which the threat intelligence optimization system described herein can repurpose the same database format.

Representation 700B shows a typical response when querying a standard geolocation database with a digital identifier, in this case the IP address “118.118.118.118”. The response is a JSON object containing standard geographical information associated with the IP address. The top-level keys, such as “continent”, “country,” “location,” “registered_country,” and “traits,” are consistent with the structure shown in FIG. 7A.

However, in contrast to the packed threat intelligence data shown in FIG. 7A, the values associated with the keys in representation 700B include conventional geolocation data. For example, the “continent” object includes a standard continent code (“AS” for Asia) and a geoname identifier. The “country” object includes a standard ISO code (“CN” for China) and its associated geoname identifier. The “location” object includes standard geographical coordinates, including an “accuracy_radius”, “latitude”, “longitude”, and “time_zone”. The “traits” object confirms the queried “ip_address”.

By comparing the conventional data representation 700B with the exemplary data representation 700A of some implementations described herein, the technological improvement becomes clear. While both utilize the same underlying MMDB format and structure, the threat intelligence optimization system repurposes the standard fields to act as containers for a single packed data field that encapsulates rich, custom, and consolidated threat intelligence. This can allow a security asset that is designed to read the standard format of representation 700B to seamlessly read the custom data of representation 700A without any modification to its own code, thereby enabling the integration of custom threat intelligence into a wide array of existing software and hardware systems.

FIG. 7C is a conceptual diagram illustrating a representation 700C of exemplary packed data retrieved from a database file for a Media Access Control (MAC) address. FIG. 7C serves to illustrate the flexibility and broad applicability of some implementations described herein, demonstrating that the threat intelligence optimization system is not limited to processing IP addresses or purely cybersecurity-related threat attributes.

Representation 700C shows the data returned when a database file is queried with a MAC address. A technological aspect illustrated here is how a non-IP identifier is handled within the MMDB-compatible structure. The “traits” object shows that the MAC address has been converted into an IPv6-compatible format, with the “ip_address” field showing a value of “::219:3dff:fef3:d199”. This conversion allows the MAC address to be stored and looked up within the same binary search tree structure used for IP addresses, enabling the system to handle a variety of digital identifier types in a unified manner.

Furthermore, FIG. 7C demonstrates the versatility of the packed data field. In this example, the “city”->“names”->“en” field is repurposed to store a descriptive string of text related to a physical asset: “Stolen during forced removal during active pursuit.”. This shows that the attribute data is not limited to structured threat intelligence, but can be any form of relevant information, including status updates or alerts for physical assets, as described further herein. Other standard fields can be similarly repurposed to store custom metadata. For example, the “continent” field can be used to store the original MAC address (“GMC|00:19:3d:f3:d1:99”) and an associated date range (“2024 Dec. 18|2024 Dec. 20”). The “country” field can be used to store a source or category name (“GMC”).

Collectively, data representation 700C demonstrates that the threat intelligence optimization system can be applied to a wide range of use cases beyond traditional IP-based threat intelligence. For example, the system can create a high-performance database for various types of digital identifiers and their associated custom attributes, enabling real-time lookups not only for cybersecurity, but for applications in asset tracking, physical security, and other domains, as described further herein.

FIG. 8A is a conceptual diagram illustrating a representation of an exemplary output 800A from a security asset after querying a database file with a digital identifier. FIG. 8A demonstrates how an existing, unmodified third-party software application can seamlessly consume and utilize the portable threat intelligence database file. In this example, the security asset is an instance of a widely used log management and analytics platform. Representation 800A shows the user interface of a development console being used to simulate an ingest pipeline.

The left panel of the interface shows the configuration of a test request. A geoip processor, which is a standard, built-in feature of the platform, is configured with a specific database_file parameter. Critically, the database_file parameter for this processor is set to “threat_intel-Enterprise.mmdb”, which is the custom database file generated by some implementations described herein, such as in FIGS. 4, 5A, and 5B. The input document for this simulation is a simple log entry containing a single digital identifier; in this case, the IP address “105.104.25.247”.

The right panel of the interface shows the result of the simulation. The platform's geoip processor has successfully performed a lookup on the input IP address using the custom database file. The original document has been enriched with a new “geoip” field. Within this field, the domain key contains the retrieved single packed data field as a serialized JSON string (“{\“threat_category\”: [\“cnc\”], \“threat_category_full\”: [\“92;1;cnc\”], . . . }”).

Output 800A demonstrates a significant technological improvement of some implementations described herein: the security asset did not require any custom code or modification to its own structure. By leveraging its native ability to read and process MMDB-format files, it was able to directly query the custom database file and retrieve the packed threat intelligence data. This validates the seamless interoperability and ease of integration that the threat intelligence optimization system provides, allowing sophisticated, custom threat data to be operationalized by a wide array of existing security systems with minimal configuration effort.

FIG. 8B is a conceptual diagram illustrating a representation of an exemplary output 800B from a security asset after querying a conventional, off-the-shelf geolocation database. FIG. 8B is provided for the purpose of comparison with FIG. 8A to illustrate the novel functionality enabled by some implementations described herein. Similar to FIG. 8A, output 800B shows the user interface of a development console simulating an ingest pipeline. The input document is identical to that used in FIG. 8A, including the IP address “105.104.25.247”.

However, in this conventional use case, the geoip processor is configured without a specific database_file parameter, causing it to use its default, built-in geolocation database. The right panel of the interface shows the result of this standard lookup. The original document has been enriched with a “geoip” field containing standard geographical information. This includes fields such as “continent_name”: “Africa”, “city_name”: “Annaba”, “country_name”: “Algeria”, and a “location” object with latitude and longitude coordinates.

By contrasting this standard output 800B with output 800A shown in FIG. 8A, the technological improvement of the threat intelligence optimization system is clear. While the consuming security asset and the input digital identifier are identical in both scenarios, the resulting enriched data is fundamentally different. FIG. 8B shows the expected output of a standard geolocation lookup. In contrast, FIG. 8A shows that when the same tool is configured to use the database file generated by the threat intelligence optimization system, it retrieves a rich, packed set of custom threat intelligence attributes instead of simple geographic data. This comparison demonstrates that some implementations described herein enable an unmodified third-party application to produce a different and more valuable output, validating the system's ability to seamlessly repurpose a standard data format for the delivery of custom intelligence.

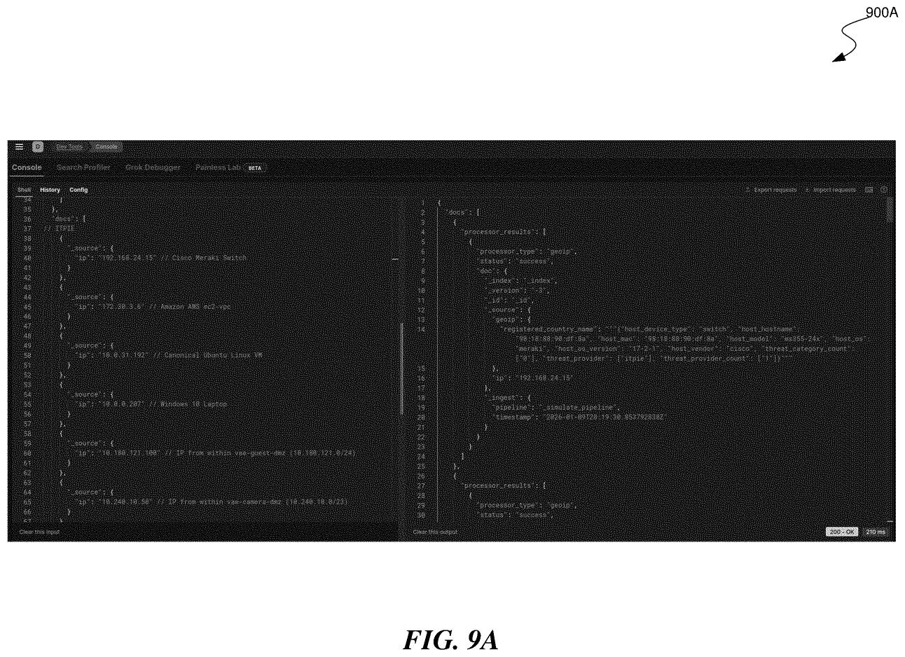

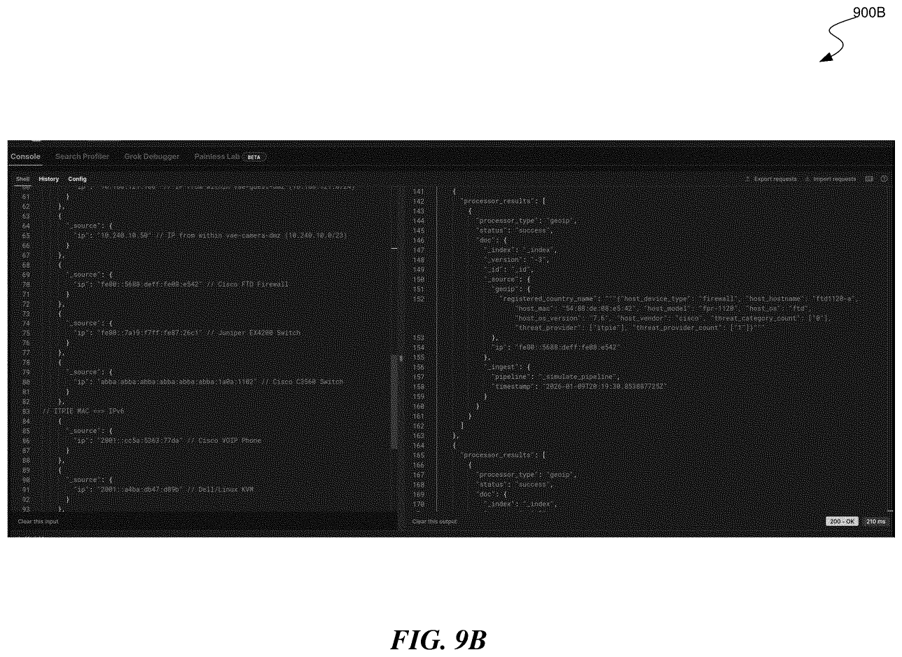

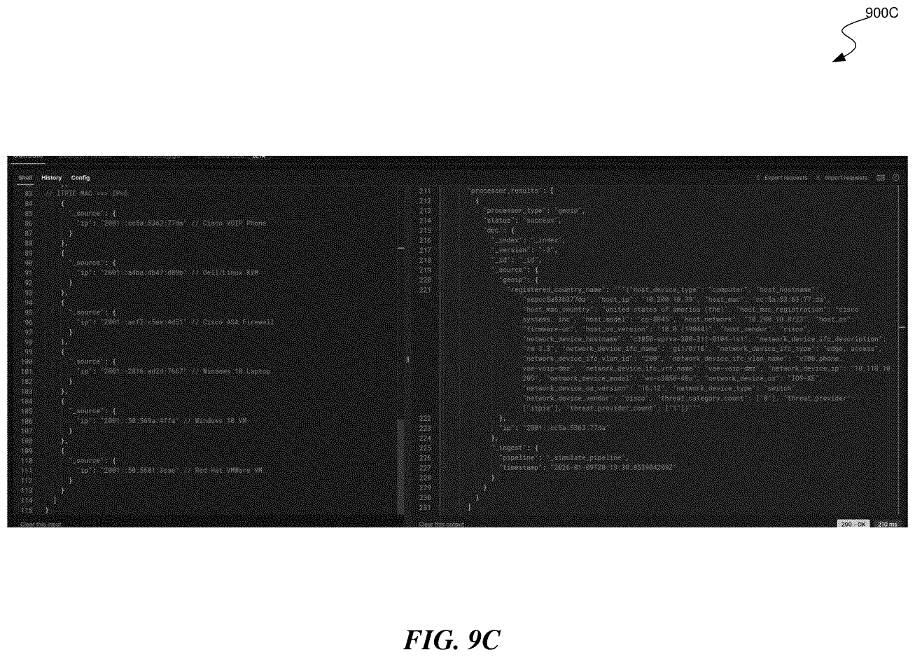

FIGS. 9A-C are conceptual diagrams illustrating representations 900A-C of additional exemplary outputs from a security asset (in this case, a SIEM tool instance) after querying a custom database file, generated according to some implementations described herein, with various digital identifiers. FIGS. 9A-C further illustrate the flexibility and richness of the data retrieved in some implementations, building upon the concepts shown in FIG. 8A. In each of FIGS. 9A-C, the left panel of representations 900A-C shows a list of input documents being simulated in an ingest pipeline, and the right panel shows the corresponding output documents, which have been enriched with a “geoip” field containing the packed attribute data retrieved from the database file.

For example, FIG. 9A shows representation 900A of the system enriching several IPv4 addresses in some implementations. In the example shown, the input document on the left contains the IP address “192.168.24.15”, noted as originating from a switch. The right panel illustrates the result of the lookup for this IP address. The original source document has been enriched with a geoip field containing detailed attributes about the associated device. These attributes include, for example, host_device_type: “switch”, host_hostname: “switch”, host_mac: “98:18:88:DF:DA:FA”, host_os: “meraki”, and host_vendor: “cisco”. This demonstrates the system's ability to retrieve a specific, detailed profile of a network hardware device based on its IP address at a point in time.

FIG. 9B shows representation 900B demonstrating the system's capability to enrich IPv6 addresses in some implementations. In this example, the input document contains the IPv6 address “fe80::5688:deff:fe08:e542”, identified as originating from a firewall. The corresponding output on the right shows the geoip field populated with relevant attributes retrieved for this identifier. The attributes include host_device_type: “firewall”, host_hostname: “ftd128-a”, host_os: “ftd”, and host_os_version: “7.6”. This example illustrates that the system's binary search tree and lookup mechanism are fully compatible with the 128-bit structure of IPv6 addresses, enabling the same rich, contextual data retrieval for modern network environments.

FIG. 9C shows representation 900C illustrating the retrieval of a highly detailed set of attributes corresponding to a historical network configuration, sometimes referred to as IP Address Management (IPAM) or device history data. In this embodiment, the input IP address is “2001:cc5a:5363:77da”, associated with a VOIP phone. The geoip field in the output contains a comprehensive snapshot of the network infrastructure associated with that IP address at a point in time. These attributes include not only device-level information (host_device_type: “computer”, host_vendor: “Cisco Systems, Inc”), but also detailed network interface and connection context that describe the precise state and configuration of the network device and its interfaces at a specific point in time, such as network_device_hostname: “c9ksw-serva-200-0104-sw1”, network_device_ifc_name: “gi1/0/15”, network_device_ifc_vlan_name: “v200-phone”, and network_device_ip: “10.118.10.1”. These fields can collectively create a detailed digital fingerprint of how and where an IP address was being used on the network, including what device was using the IP address, which physical port on that device was it assigned to, what network segment it was a part of, what the purpose of that port was, etc. In some implementations, this set of attributes can be used to create a historical IP Address Management (IPAM) database. This demonstrates a powerful use case of the system: creating a high-speed, queryable historical record of network state, allowing an analyst to instantly determine exactly which device, on which switch port, and in which VLAN an IP address was being used.

While the implementations described herein are primarily described with respect to cybersecurity and threat intelligence applications, it is contemplated the underlying methods and systems can provide high-speed data retrieval that can be broadly applicable to any domain requiring real-time lookups based on a digital identifier or other identifier of any type and/or format. As would be appreciated by one skilled in the art, the technological improvements described herein (e.g., the generation of a portable, high-performance, existing database format-compatible file) can be agnostic to the content of the attributes stored within it. The following are exemplary descriptions of how some implementations described herein can be used in non-cybersecurity applications.

### 1. Physical Asset Tracking and Management

In one example, the system described herein can be used to create a database for tracking and managing physical assets within an organization or environment. In such an example, the digital identifiers need not be malicious indicators, but rather unique labels for physical assets. Examples include a Media Access Control (MAC) address of a device, an RFID tag identifier, a serial number, or any other unique identifier. In some implementations, the packed data field of attributes could contain operational metadata instead of threat attributes. This could include, for example, ownership information (e.g., department, assigned user, etc.), physical location (e.g., building, floor, room, etc.), operational status (e.g., “in service,” “maintenance required,” “decommissioned,” etc.), purchase date, warranty information, and/or the like.

In use, an enterprise inventory management system (e.g., an exemplary “security asset” as described herein) can periodically scan a network. If it detects a device with a specific MAC address, it can query the custom database file, generated in a similar manner as that described above. If the retrieved packed data field, once unpacked, indicates the asset's status is “decommissioned,” the system can automatically generate a security alert for an unauthorized device on the network. In another example, if the MAC address is not included in the custom database file (e.g., traversal of the binary search tree ends at a node including no pointer, and thus having no associated stores attribute data), the system can automatically generate a security alert for an unauthorized device on the network. This can allow for real-time physical asset compliance and security monitoring.

### 2. Logistics and Supply Chain Management

In a second example, the system can be used to track products throughout a supply chain. In this example, the digital identifiers can include an ID for a shipping container, an ID broadcast by a Bluetooth Low Energy (BLE) or RFID tag on a pallet, etc. The packed data field can include logistical information, such as the cargo manifest, type of products, destination, origin, temperature requirements for sensitive goods, scheduled delivery time, value of products, etc. An automated system (e.g., a “security asset” described herein) at a distribution center's gate can read a container's ID. It can then perform a real-time lookup in the database file. Based on the retrieved attributes indicating “cargo”: “Perishable Goods” and “destination”: “Dock 7”, the system can automatically route the truck including the products to a refrigerated loading dock without manual intervention, improving efficiency and reducing spoilage risk.

### 3. Public Safety and Law Enforcement

As illustrated in part by FIG. 7C, in a third example, the system can be used as a high-speed lookup tool for public safety applications. In this example, the digital identifiers can include a driver's license or other identification card number, a MAC address from a vehicle's infotainment system, an IMEI from a reported stolen phone, a license plate number converted to a binary format, a vehicle identification number (VIN), etc. The packed data field can include critical, time-sensitive information. For example, for the MAC address shown in FIG. 7C, the attribute can be a descriptive string: “Stolen during forced removal during active pursuit.” Other attributes in various examples can include a missing person's case number, a vehicle's make and model, a flag indicating an association with criminal activity and/or a particular type of criminal activity, etc.

In an exemplary use case, a network of sensors across a city can detect a vehicle's broadcasted Wi-Fi MAC address and/or a network of cameras can detect a vehicle's license plate. A central monitoring system (e.g., a “security asset” as described herein) can query a database file, generated in a similar manner as described above, in real-time. Upon retrieving a “Stolen” attribute, the system can automatically dispatch an alert to nearby law enforcement units with the vehicle's last known location, providing immediate, actionable intelligence.

In some implementations, in these and other use cases, the fundamental underlying process described herein can remain the same: a digital identifier can be used to perform an extremely fast, in-memory lookup to retrieve a rich set of contextual attributes, which can then drive an automated, real-time action. The flexibility to define both the identifier and its associated attributes allows some implementations described herein to serve as a powerful data operationalization platform across numerous industries and applications.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for standardizing and operationalizing threat intelligence data for cybersecurity applications, the method comprising:
obtaining, from one or more data sources, multiple sets of threat intelligence data corresponding to detected cybersecurity threats,
wherein each set of threat intelligence data includes a digital identifier and multiple attributes associated with the digital identifier;
for each set of the multiple sets of threat intelligence data:
transforming the obtained set of threat intelligence data into a unified data model, including packing the multiple attributes into a single packed data field; and
serializing the unified data model into a database file, the database file including a binary search tree and a data section,
wherein the binary search tree is populated with multiple nodes, the nodes representing portions of digital identifiers, including portions of the digital identifier of the obtained set of threat intelligence data, and including pointers, and
wherein the data section stores multiple packed data fields, including the single packed data field corresponding to the obtained set of threat intelligence data, at locations corresponding to the pointers; and
transmitting the database file to a security asset,
wherein the security asset:
obtains an existing digital identifier;
locates an existing pointer by traversing the binary search tree of the database file using the existing digital identifier; and
retrieves, using the existing pointer, an existing packed data field from the data section of the database file.

2. The method of claim 1, wherein the digital identifier includes a network identifier or a device identifier.

3. The method of claim 1, wherein the database file is structured to be compatible with a MaxMind Database (MMDB) format without modification to a schema of the MMDB format.

4. The method of claim 1, wherein the multiple attributes include two or more of a threat description, a threat category, a threat classification, a threat source, a threat score, or any combination thereof.

5. The method of claim 1, wherein the single packed data field is a serialized data object.

6. The method of claim 1, wherein the security asset further:
extracts a plurality of threat attributes corresponding to the existing digital identifier by unpacking the retrieved existing packed data field.

7. The method of claim 6, wherein the security asset further:
operationalizes a security action based on one or more of the extracted plurality of threat attributes.

8. The method of claim 7, wherein the security asset further:
automatically performs the security action.

9. The method of claim 7, wherein the security action includes one or more of blocking a connection from the existing digital identifier, redirecting the existing digital identifier, requiring additional authentication of a user associated with the digital identifier, storing the one or more of the extracted plurality of threat attributes in a database, or any combination thereof.

10. The method of claim 1, wherein the security asset is a firewall, a web server, a proxy, a data router, or a security information and event management (SIEM) tool.

11. A computer-readable storage medium storing instructions, for standardizing and operationalizing contextual data for real-time lookups, the instructions, when executed by a computing system, cause the computing system to:
obtain, from one or more data sources, multiple data sets, wherein each data set includes a digital identifier and multiple attributes associated with the digital identifier;
for one or more sets of the multiple data sets:
transforming the obtained data set into a unified data model, including packing the multiple attributes into a single packed data field; and
serializing the unified data model into a database file, the database file including a binary search tree and a data section,
wherein the binary search tree is populated with multiple nodes, the nodes representing portions of digital identifiers, including A) portions of the digital identifier of the obtained data set and B) pointers,
wherein the data section stores multiple packed data fields, including the single packed data field corresponding to the obtained data set, at locations corresponding to the pointers; and
transmitting the database file to a consuming computing system,
wherein the consuming computing system:
obtains an existing digital identifier;
locates an existing pointer by traversing the binary search tree of the database file using the existing digital identifier; and
retrieves, using the existing pointer, an existing packed data field from the data section of the database file.

12. The computer-readable storage medium of claim 11, wherein the multiple sets of data include multiple sets of threat intelligence data corresponding to detected cybersecurity threats.

13. The computer-readable storage medium of claim 11, wherein the database file is structured to be compatible with a preexisting database format without modification to a format schema of the preexisting database format.

14. The computer-readable storage medium of claim 13, wherein the preexisting database format is a MaxMind Database (MMDB) format.

15. The computer-readable storage medium of claim 11, wherein the consuming computing system further:
extracts a plurality of existing attributes corresponding to the existing digital identifier by unpacking the retrieved existing packed data field.

16. The computer-readable storage medium of claim 15, wherein the consuming computing system further:
operationalizes an action based on one or more of the extracted plurality of existing attributes.

17. The computer-readable storage medium of claim 16, wherein the consuming computing system further:
automatically performs the operationalized action.

18. The computer-readable storage medium of claim 16, wherein the automatic action includes inputting the one or more of the extracted plurality of existing attributes to a machine learning model.

19. A computing system for standardizing contextual data for real-time retrieval, the computing system comprising:
one or more processors; and
one or more memories storing instructions that, when executed by the one or more processors, cause the computing system to:
obtain, from one or more data sources, multiple data sets, wherein each data set includes a digital identifier and multiple attributes associated with the digital identifier;
for two or more sets of the multiple data sets:
transform the obtained data set into a unified data model, including packing the multiple attributes into a single packed data field; and
serialize the unified data model into a database file, the database file including a binary search tree and a data section,
wherein the binary search tree is populated with multiple nodes, the nodes representing portions of digital identifiers, including A) portions of the digital identifier of the obtained data set and B) pointers,
wherein the data section stores multiple packed data fields, including the single packed data field corresponding to the obtained data set, at locations corresponding to the pointers; and
transmit the database file to a consuming computing system,
wherein the consuming computing system:
obtains an existing digital identifier;
locates an existing pointer by traversing the binary search tree of the database file using the existing digital identifier; and
retrieves, using the existing pointer, an existing packed data field from the data section of the database file.

20. The computing system of claim 19, wherein the consuming computing system further:
extracts a plurality of existing attributes corresponding to the existing digital identifier by unpacking the retrieved existing packed data field;
operationalizes an action based on one or more of the extracted plurality of existing attributes; and
automatically performs the action.
